(19) United States
(12) Patent Application Publication
(10) Pub. No.: US 2025/0316943 A1
(43) Pub. Date: Oct. 9, 2025

(54) THERMALLY MANAGED OPTICAL FIBER

(71) Applicants: Magnus ENGHOLM, CLEMSON, SC (US); CLEMSON UNIVERSITY, CLEMSON, SC (US)

(72) Inventors: BAILEY MEEHAN, CLEMSON, SC (US); THOMAS W. HAWKINS, CLEMSON, SC (US); JOHN BALLATO, CLEMSON, SC (US); MAGNUS ENGHOLM, CLEMSON, SC (US)

(21) Appl. No.: 19/169,762

(22) Filed: Apr. 3, 2025

Related U.S. Application Data
(60) Provisional application No. 63/573,519, filed on Apr. 3, 2024.

(51) Int. Cl. H01S 3/04; H01S 3/067

(52) U.S. Cl. CPC H01S 3/0408; H01S 3/06716

(57) ABSTRACT

The present application is generally directed to compositions and methods for forming glass matrices which may exhibit anti-Stokes fluorescence. The glass matrices of the present disclosure are formed such that a thermal characteristic can be tuned, such as the extent to which cooling by anti-Stokes fluorescence occurs. Optical fibers, such as those used in lasers, may be formed out of the presently described glass matrices. In embodiments, glass matrices of the present disclosure may form a cladding layer around an optical fiber. Further, glass matrices of the present disclosure may be used in combination with a device or to provide cooling to said device.

### CROSS REFERENCE TO RELATED APPLICATION

This application claims filing benefit of U.S. Provisional Patent Application Ser. No. 63/573,519 having a filing date of Apr. 3, 2024, which is incorporated herein by reference for all purposes.

### BACKGROUND

The increasing use of lasers in different applications and their adoption in a wide variety of technologies brings with it a desire for ever increasing output powers and efficiencies. Lasers provide a variety of benefits to advanced manufacturing techniques where they are already used, such as in marking, precision cutting, and welding of materials. They also enable many techniques in additive manufacturing and materials processing that are in various states of development. Various materials processing and manufacturing techniques require different power levels and spot sizes. Output powers increased rapidly early in development, but have plateaued significantly in recent years.

Optical fibers serve as crucial components in a variety of photonic technologies, including lasers. In laser systems, they can act as gain media, delivery mechanisms, or both, facilitating the generation and shaping of laser beams. For optical transmission, fibers provide a low-loss pathway for light signals, allowing for long-distance communication with minimal signal degradation. Furthermore, optical fibers are essential in light amplifiers, where they are doped with rare earth elements to boost the intensity of weak optical signals. Their ability to confine light within a small core and their compatibility with various optical components make them indispensable in modern photonics. Beam combining of multiple fiber amplifiers has enabled the creation of laser systems with staggeringly high output powers, but progress towards improved output of each individual fiber has slowed significantly. Chief among the issues that prevent further power scaling of fiber amplifiers are those associated with optical nonlinearities and thermal management.

### SUMMARY

The present disclosure is generally directed to glass matrices which exhibit cooling through anti-Stokes fluorescence. In one embodiment is disclosed an optical fiber comprising a core comprising a silica matrix and an active dopant disposed within the silica matrix, wherein a trivalent form of the active dopant is present in the silica matrix in an amount greater than 2.1 wt. % and a divalent form of the active dopant is present in the silica matrix in an amount less than 1.0 wt. ppm.

Further, the present disclosure relates to a cooling system for an optical fiber, the system comprising an optical fiber core and a cladding disposed on an exterior surface of the optical fiber core, the cladding comprising a silica matrix and an active dopant disposed within the silica matrix, wherein a trivalent form of the active dopant is present in the silica matrix in an amount greater than 5.6 wt. % and a divalent form of the active dopant is present in the silica matrix in an amount less than 1.0 wt. ppm.

Additionally, the present disclosure, in embodiments, relates to a silica matrix comprising a silica matrix and an active dopant disposed within the silica matrix, wherein a trivalent form of the active dopant is present in the silica matrix in an amount greater than 8.9 wt. %.

### BRIEF DESCRIPTION OF THE FIGURES

A full and enabling disclosure of the present subject matter, including the best mode thereof to one of ordinary skill in the art, is set forth more particularly in the remainder of the specification, including reference to the accompanying FIGURES in which:

FIG. 1 is a graph showing the temperature change as a function of pump power for optical fibers of the present disclosure.

### DETAILED DESCRIPTION

Reference will now be made in detail to various embodiments of the disclosed subject matter, one or more examples of which are set forth below. Each embodiment is provided by way of explanation of the subject matter, not limitation thereof. In fact, it will be apparent to those skilled in the art that various modifications and variations may be made in the present disclosure without departing from the scope or spirit of the subject matter. For instance, features illustrated or described as part of one embodiment, may be used in another embodiment to yield a still further embodiment.

As used herein, the term “or” is inclusive unless stated otherwise. For instance, if a computer requires A or B to be true in order to perform operation C, the case of both A and B being true will satisfy the condition necessary for C to occur. That is, “or” is inclusive of A, B, and A and B.

As described in the Background above, optical fibers are an increasingly common component of fiber optic systems, such as laser systems. Optical fibers, and lasers in general, have found increasing use across multiple industries-defense, manufacturing, telecommunications, scientific research, construction and other industries. With increasing adoption, the drive for higher power lasers has increased. Further, amplifiers can be used to increase the power of a laser. For instance, telecommunication systems often span long distances where attenuation, or other forms of signal loss, can be an issue in the transmission of a laser between its origin and its destination. Therefore, amplifiers have been used in order to periodically “boost” the power of the signal.

The ubiquity of lasers belies their utility. However, the act of lasing, i.e., stimulated emission, is fundamentally a heat-generating (i.e., exothermic) process. The amount of heat is determined by the ‘quantum defect’ which relates to the wavelength of the pump, λₚ, and that of the laser output, λₛ, as:

$$Quatum Defect = 1 - \frac{{λ}_{s}}{{λ}_{p}}$$

With high powered lasers, however, comes an increase in the required thermal management of the laser. While the silica glass matrix of optical fibers can often withstand high temperatures, protective claddings or coatings may not be able to withstand the high temperature generated in a laser. Conventionally, thermal management of a laser requires active cooling systems—systems which are thermal contact with a lasing medium, the systems possibly comprising fans, heatsinks, water-cooling or other such cooling devices. The use of these devices can increase the bulk of a laser, as well as increase the cost of a laser system.

Furthermore, active cooling devices are dependent on the rate of heat transfer between the optical fibers and the convective medium. As the heat-generating potential in an optical fiber is much greater than the ability of conventional methods to remove said heat, a scaling issue for thermal management exists in high powered lasers. Additionally, while the integrity of the silica matrix be unchanged in high temperatures, the ability of the matrix to transmit a signal may be hindered. Such a hindrance to signal transmission may be in the form of transverse mode instability.

In general, the present disclosure is directed to optical fibers which exhibit anti-Stokes fluorescence, and methods of manufacture thereof. Anti-Stokes fluorescence is the phenomenon where a material spontaneously emits a photon of shorter wavelength (higher energy) than that of the pump photon. The energy difference between the lower energy pump and higher energy fluorescence comes from the phonons of the (glass matrix) host which provide energy to thermalize the electrons in the excited state from which the emission originates. If the anti-Stokes fluorescence is not subsequently absorbed by the fiber and exits the system, the light carries away that energy that came from the phonons of the host glass, thus anti-Stokes fluorescence affords a mechanism by which thermal energy can be removed from a system leading to cooling. Discussed further herein are the materials that may make up such an optical fiber that exhibit efficient anti-Stokes fluorescence, as well as the methods of manufacture therefore and potential use cases.

In glass matrices of the present disclosure, an active dopant which may exhibit anti-Stokes fluorescence is disposed within said matrix. The active dopant may comprise ytterbium. The present inventors have found that, by controlling the extent to which a glass matrix comprises trivalent ytterbium or divalent ytterbium, or the ratio thereof, the cooling properties via anti-Stokes fluorescence of a glass matrix may be adjusted. Specifically, the inventors have found that minimizing divalent ytterbium present in a glass matrix may allow for efficient cooling through anti-Stokes fluorescence. Further to this end, the present inventors have identified several process parameters which may be adjusted during standard chemical vapor deposition processes to allow for the minimization of divalent ytterbium. Thus, the present disclosure enables one of skill to manufacture glass matrix materials which may efficiently cool using anti-Stokes fluorescence.

An optical fiber may comprise a glass matrix material, with dopants disposed therein. The dopants are not particularly limited, but may include a material which exhibits anti-Stokes fluorescence or active dopant, a lasing dopant and a matrix-defining dopant. In embodiments, dopants of the present disclosure may be present in the glass matrix in the form of an oxide or silicate.

The glass matrix may comprise silica, or derivatives thereof. Such derivates, while not particularly limited, may comprise aluminosilicate, borosilicate, borophosphosilicate, aluminophosphosilicate, phosphosilicate, or mixtures thereof. A specific derivative of silica may be formed when a matrix-defining dopant is included within the glass silica matrix. For instance, the aluminophosphosilicate glass may comprise matrix-defining dopants of aluminum and phosphorus.

Dopants may comprise an active dopant which exhibits anti-Stokes fluorescence. The active dopant may comprise a rare earth material including, but not limited to, lanthanum, cerium, yttrium, praseodymium, dysprosium, scandium, neodymium, samarium, europium, promethium, terbium, gadolinium, lutetium, ytterbium, erbium, thulium, holmium or mixtures thereof. In embodiments, the active dopant may comprise ytterbium, erbium, thulium, holmium or mixtures thereof. In embodiments, the active dopant may comprise ytterbium. The active dopant may be present in the glass matrix at a wt. % greater than 0.1 wt. %, such as greater than 0.2 wt. %, such as greater than 0.5 wt. %, such as greater than 0.8 wt. %, such as greater than 1.1 wt. %, such as greater than 1.4 wt. %, such as greater than 1.7 wt. %, such as greater than 2.0 wt. %, such as greater than 2.1 wt. %, such as greater than 2.3 wt. %, such as greater than 2.6 wt. %, such as greater than 3.0 wt. %, such as greater than 3.2 wt. %, such as greater than 3.5 wt. %, such as greater than 3.8 wt. %, such as greater than 4.1 wt. %, such as greater than 4.4 wt. %, such as greater than 4.7 wt. %, such as greater than 5.0 wt. %, such as greater than 5.3 wt. %, such as greater than 5.6 wt. %, such as greater than 5.9 wt. %, such as greater than 6.2 wt. %, such as greater than 6.5 wt. %, such as greater than 6.8 wt. %, such as greater than 7.1 wt. %, such as greater than 7.4 wt. %, such as greater than 7.7 wt. %, such as greater than 8.0 wt. %, such as greater than 8.3 wt. %, such as greater than 8.6 wt. %, such as greater than 8.9 wt. %, such as greater than 9.2 wt. %, such as greater than 9.5 wt. %, such as greater than 9.8 wt. %, such as greater than 10.1 wt. %. The active dopant may be present in the glass matrix at a wt. % less than 11.5 wt. %, such as less than 11.2 wt. %, such as less than 10.9 wt. %, such as less than 10.6 wt. %, such as less than 10.3 wt. %, such as less than 10.0 wt. %, such as less than 9.7 wt. %, such as less than 9.4 wt. %, such as less than 9.1 wt. %, such as less than 8.8 wt. %, such as less than 8.5 wt. %, such as less than 8.2 wt. %, such as less than 7.9 wt. %, such as less than 7.6 wt. %, such as less than 7.3 wt. %, such as less than 7.0 wt. %, such as less than 6.7 wt. %, such as less than 6.4 wt. %, such as less than 6.1 wt. %, such as less than 5.8 wt. %, such as less than 5.5 wt. %, such as less than 5.2 wt. %, such as less than 4.9 wt. %, such as less than 4.6 wt. %, such as less than 4.3 wt. %, such as less than 4.0 wt. %, such as less than 3.7 wt. %, such as less than 3.4 wt. %, such as less than 3.1 wt. %, such as less than 2.8 wt. %, such as less than 2.5 wt. %, such as less than 2.2 wt. %, such as less than 1.9 wt. %, such as less than 1.6 wt. %, such as less than 1.3 wt. %, such as less than 1.0 wt. %, such as less than 0.7 wt. %, such as less than 0.3 wt. %.

Further dopants may comprise lasing dopants. Lasing dopants are dopants which can achieve population inversion via pumping. Such lasing dopants may comprise a rare earth or a transition metal such titanium or chromium. Further, in embodiments, the active dopant and the lasing dopant may comprise the same material. The lasing dopant may be present in the glass matrix at a wt. % greater than 0.2 wt. %, such as greater than 0.5 wt. %, such as greater than 0.8 wt. %, such as greater than 1.1 wt. %, such as greater than 1.4 wt. %, such as greater than 1.7 wt. %, such as greater than 2.0 wt. %, such as greater than 2.3 wt. %, such as greater than 2.6 wt. %, such as greater than 2.9 wt. %, such as greater than 3.2 wt. %, such as greater than 3.5 wt. %, such as greater than 3.8 wt. %, such as greater than 4.1 wt. %, such as greater than 4.4 wt. %, such as greater than 4.7 wt. %, such as greater than 5.0 wt. %, such as greater than 5.3 wt. %, such as greater than 5.6 wt. %, such as greater than 5.9 wt. %, such as greater than 6.2 wt. %, such as greater than 6.5 wt. %, such as greater than 6.8 wt. %, such as greater than 7.1 wt. %, such as greater than 7.4 wt. %, such as greater than 7.7 wt. %, such as greater than 8.0 wt. %, such as greater than 8.3 wt. %, such as greater than 8.6 wt. %, such as greater than 8.9 wt. %. The lasing dopant may be present in the glass matrix at a wt. % less than 9.1 wt. %, such as less than 8.8 wt. %, such as less than 8.5 wt. %, such as less than 8.2 wt. %, such as less than 7.9 wt. %, such as less than 7.6 wt. %, such as less than 7.3 wt. %, such as less than 7.0 wt. %, such as less than 6.7 wt. %, such as less than 6.4 wt. %, such as less than 6.1 wt. %, such as less than 5.8 wt. %, such as less than 5.5 wt. %, such as less than 5.2 wt. %, such as less than 4.9 wt. %, such as less than 4.6 wt. %, such as less than 4.3 wt. %, such as less than 4.0 wt. %, such as less than 3.7 wt. %, such as less than 3.4 wt. %, such as less than 3.1 wt. %, such as less than 2.8 wt. %, such as less than 2.5 wt. %, such as less than 2.2 wt. %, such as less than 1.9 wt. %, such as less than 1.6 wt. %, such as less than 1.3 wt. %, such as less than 1.0 wt. %, such as less than 0.7 wt. %, such as less than 0.4 wt. %.

Additionally dopants may comprise matrix-defining dopants. These dopants may serve to alter a fundamental quality of a glass matrix. Such dopants include, but are not limited to, boron, phosphorus, aluminum, fluorine, or mixtures thereof. A matrix-defining dopant may be present in the glass matrix in an amount greater than 0.5 wt. %, such as greater than 1.0 wt. %, such as greater than 1.5 wt. %, such as greater than 2.0 wt. %, such as greater than 2.5 wt. %, such as greater than 3.0 wt. %, such as greater than 3.5 wt. %, such as greater than 4.0 wt. %, such as greater than 4.5 wt. %, such as greater than 5.0 wt. %, such as greater than 5.5 wt. %, such as greater than 6.0 wt. %, such as greater than 6.5 wt. %, such as greater than 7.0 wt. %, such as greater than 7.5 wt. %, such as greater than 8.0 wt. %, such as greater than 8.5 wt. %, such as greater than 9.0 wt. %, such as greater than 9.5 wt. %, such as greater than 10.0 wt. %, such as greater than 10.5 wt. %, such as greater than 11.0 wt. %, such as greater than 11.5 wt. %, such as greater than 12.0 wt. %, such as greater than 12.5 wt. %, such as greater than 13.0 wt. %, such as greater than 13.5 wt. %, such as greater than 14.0 wt. %, such as greater than 14.5 wt. %, such as greater than 15.0 wt. %, such as greater than 15.5 wt. %, such as greater than 16.0 wt. %, such as greater than 16.5 wt. %, such as greater than 17.0 wt. %, such as greater than 17.5 wt. %, such as greater than 18.0 wt. %, such as greater than 18.5 wt. %, such as greater than 19.0 wt. %, such as greater than 19.5 wt. %, such as greater than 20.0 wt. %. A matrix-defining dopant may be present in the glass matrix in an amount less than 21.0 wt. %, such as less than 20.5 wt. %, such as less than 20.0 wt. %, such as less than 19.5 wt. %, such as less than 19.0 wt. %, such as less than 18.5 wt. %, such as less than 18.0 wt. %, such as less than 17.5 wt. %, such as less than 17.0 wt. %, such as less than 16.5 wt. %, such as less than 16.0 wt. %, such as less than 15.5 wt. %, such as less than 15.0 wt. %, such as less than 14.5 wt. %, such as less than 14.0 wt. %, such as less than 13.5 wt. %, such as less than 13.0 wt. %, such as less than 12.5 wt. %, such as less than 12.0 wt. %, such as less than 11.5 wt. %, such as less than 11.0 wt. %, such as less than 10.5 wt. %, such as less than 10.0 wt. %, such as less than 9.5 wt. %, such as less than 9.0 wt. %, such as less than 8.5 wt. %, such as less than 8.0 wt. %, such as less than 7.5 wt. %, such as less than 7.0 wt. %, such as less than 6.5 wt. %, such as less than 6.0 wt. %, such as less than 5.5 wt. %, such as less than 5.0 wt. %, such as less than 4.5 wt. %, such as less than 4.0 wt. %, such as less than 3.5 wt. %, such as less than 3.0 wt. %, such as less than 2.5 wt. %, such as less than 2.0 wt. %, such as less than 1.5 wt. %, such as less than 1.0 wt. %. The presence of matrix-defining dopants can increase the extent to which an active dopant can be loaded while maintaining a singular glass phase.

Further, the glass matrix may comprise impurities. Impurities may comprise parasitic dopants or defects in the glass matrix, such as terminal hydroxyl groups. In embodiments, it is desired to minimize the extent to which the glass matrix comprises any impurities. For instance, the glass matrix may comprise between 5.0 and 100 parts per million of impurities, such as between 10 and 70 parts per million of impurities, such as between 20 and 50 parts per million of impurities. Impurities may be included in the glass matrix by way of inclusion of a dopant. Thus, the purity of a dopant may have an effect on the total impurity content in a glass matrix. Further, the glass matrix may comprise terminal hydroxyl groups in an amount between 0.1 and 15 wt. ppm, such as between 1.0 and 10 wt. ppm. In embodiments, the glass matrix may comprise terminal hydroxyl groups in an amount less than 10 wt. ppm, such as less than 7 wt. ppm, such as less than 4.5 wt. ppm.

Impurities can have a variety of effects. The impurities can lead to increase in attenuation in an optical fiber. Signal attenuation can take a multitude of forms. In a first instance, attenuation can be in the form of an optical fiber absorbing photons of the light beam, which can increase the temperature of an optical fiber. Further, signal attenuation may comprise scattering of the light beam, wherein total internal reflection is lost, and photons exit the optical fiber.

Further, while some impurities may serve to directly absorb and convert photons to heat, others may drive quenching. Quenching refers to a variety of energy-transfer processes that result in nonradiative relaxation. Thus, impurities can serve to increase heat in an optical fiber through direct absorption, or through parasitic quenching.

Impurities may also arise from a chemical conversion of a dopant or portion of the glass matrix. One such dopant that can be converted into an impurity during the manufacturing process is the active dopant. The present inventors have found that the active dopant, such as ytterbium, may be present in the glass matrix as at least two different species with varying valences. For instance, the active dopant may comprise trivalent ytterbium, Yb³⁺, and an impurity form of ytterbium may comprise divalent ytterbium, Yb²⁺.

While the active dopant, when comprising trivalent ytterbium, can exhibit anti-Stokes fluorescence upon absorption of a photon, divalent ytterbium can exhibit a nonradiative relaxation upon absorption of a photon. Further, the absorption of a photon, and subsequent release of phonons by divalent ytterbium increases the thermal energy in an optical fiber greater than the amount of heat removed from an optical fiber by anti-Stokes fluorescence. In this way, a relatively small concentration of divalent ytterbium in comparison trivalent ytterbium can outweigh the cooling effects of trivalent ytterbium.

Divalent ytterbium can cause further heating via parasitic quenching. Excited trivalent ytterbium ions can transfer its energy to a neighboring divalent ytterbium ion where that energy is released non-radiatively as phonons.

There are therefore two mechanisms by which divalent ytterbium can outweigh the beneficial effects of trivalent ytterbium-attenuation and subsequent thermal release, and parasitic quenching. Thus, an inventive feature of the present disclosure is the minimization of divalent ytterbium in a glass matrix. A glass matrix of the present disclosure may comprise divalent ytterbium in an amount greater than 0.0 wt. ppm, such as greater than 0.3 wt. ppm, such as greater than 0.6 wt. ppm, such as greater than 0.9 wt. ppm, such as greater than 1.2 wt. ppm, such as greater than 1.5 wt. ppm, such as greater than 1.8 wt. ppm, such as greater than 2.1 wt. ppm, such as greater than 2.4 wt. ppm. In embodiments, a glass matrix may comprise divalent ytterbium in an amount such as less than 2.5 wt. ppm, such as less than 2.2 wt. ppm, such as less than 1.9 wt. ppm, such as less than 1.6 wt. ppm, such as less than 1.3 wt. ppm, such as less than 1.0 wt. ppm, such as less than 0.7 wt. ppm, such as less than 0.4 wt. ppm, such as less than 0.2 wt. ppm.

Glass matrices with the compositions as described may be formed, in some embodiments, using the method described below. Said glass fibers may be useful in addressing thermal management as detailed above. For instance, by selection of the concentration of ytterbium within the glass matrix, the extent of cooling at a given pump wavelength and power may be tuned. By varying the ratio of trivalent to divalent ytterbium, or other such impurities as listed above, an optical fiber which exhibits cooling upon pumping may be obtained. Further, in embodiments, tuning of the concentration of trivalent ytterbium can allow for an optical fiber to maintain a temperature for a given pump power. An optical fiber that maintains a given temperature for a given pump power may be called an athermal optical fiber. An athermal optical fiber may be used in a variety of applications, such as those wherein slight temperature deviations can have undesired effects.

An inventive feature of the present disclosure is realized in the method by which optical fibers may be manufactured, which is described hereinafter.

One advantage of the present disclosure is that optical fibers can be produced using chemical vapor deposition processes. Thus the fibers can be produced at a relatively high throughput. During the CVD process, various process parameters can be controlled in order to inhibit the formation of divalent active dopants. For example, the process can be conducted in the presence of a hydrogen and/or hydroxide scavenger, such as chlorine. The scavenger can limit hydrogen and/or hydroxide diffusion or availability which are believed to cause divalent formation. Alternatively, the CVD process can use electric heaters or other heaters that do not produce hydrogen or hydroxide species.

Glass matrices can be manufactured in a variety of manners. For instance, methods include modified chemical vapor deposition, outside vapor deposition and vapor axial deposition. Further methods may include molten core methods.

Modified chemical vapor deposition may comprise a plurality of steps. Said plurality of steps may comprise preheating of a deposition tube, etching/cleaning of the deposition tube, polishing of the deposition tube, cladding deposition, core deposition, solution doping, hydroxyl removal, sintering and collapse.

The deposition tube may be preheated in order to provide a completely dry deposition tube. The deposition tube itself may comprise fused-silica. Preheating of the deposition tube may comprise heating the tube and flowing oxygen, helium or a mixture thereof through the deposition tube. The above gases may be flowed through the deposition tube at a rate of, independently or jointly, between 1000 and 5000 standard cubic centimeters per minute (sccm), such as between 1500 and 3000 sccm. In embodiments, the deposition tube may be preheated to a temperature between 1500° C. and 2000° C., such as between 1600° C. and 1850° C. This may be accomplished by passing a flame under the deposition tube at a specific traverse speed, such as a speed between 100 and 400 millimeters per minute, such as between 150 and 300 millimeters per minute. Further, the burner may traverse across the deposition tube a plurality of times, such as between 1 and 6 times, such as 3 times.

The deposition tube may be etched/cleaned by passing a variety of gases through the deposition tube at elevated temperatures. For instance, oxygen, helium, and fluorine-containing gases, such as fluorocarbons and sulfur hexafluoride, may be flowed through the deposition tube. The flow rates of such gases may be, independently or jointly, between 5 and 2000 sccm. For instance, oxygen may be flowed through at a rate between 500 and 1500 sccm, helium may be flowed through at a rate between 250 and 750 sccm, fluorocarbons may be flowed through at a rate between 50 and 200 sccm, and sulfur hexafluoride may be flowed through at a rate between 5 and 30 sccm. In embodiments, the deposition tube may be preheated to a temperature between 1900° C. and 2300° C., such as between 2000° C. and 2200° C. This may be accomplished by passing a flame under the deposition tube at a specific traverse speed, such as a speed between 100 and 400 millimeters per minute, such as between 150 and 300 millimeters per minute. Further, the flame may traverse across the deposition tube a plurality of times, such as between 1 and 6 times, such as 3 times.

The deposition tube may be polished by cessation of the flow of fluorine-containing gases and increase of the temperature to a temperature, such as to a temperature of between 2100° C. and 2300° C. The flow rates of the gases, flame traverse speed, and number of traverses of the flame may be the same as in the etching/cleaning step.

A cladding deposited in the fourth step may comprise a thin, fully densified silica layer to ensure a pristine surface for core deposition. This step may comprise flowing oxygen, helium, and silicon tetrachloride (SiCl₄) through the deposition tube. The rate of the flow of the above gases may be between 500 and 1500 sccm for oxygen, between 1000 and 2000 sccm for helium and between 200 and 1000 sccm for silicon tetrachloride. Further, a plurality of layers may be deposited, which can be controlled by altering the number of passes of the flame across the deposition tube. For instance, for a flame traverse speed of between 100 and 200 millimeters per minute, a flame may traverse across the deposition tube between 1 and 10 times, depending on the desired number of cladding layers.

In the step of core deposition, volatilized glass matrix components may be flowed through the deposition tube, in addition to oxygen and helium. For instance, oxygen may be flowed through at a rate of between 150 and 450 sccm, helium may be flowed through at a rate of between 200 and 400 sccm, and silicon tetrachloride may be flowed through at a rate of between 100 and 200 sccm. Furthermore, the temperature of the flame may be between 1350° C. and 1700° C. The flame may traverse the deposition tube at a rate between of 100 and 200 millimeters per minute, and the flame may traverse the deposition tube 1 to 4 times. The core deposition step may results in the formation of a core in the deposition tube, the core comprising a plurality of glass microparticles.

In embodiments, the volatilized glass precursors may comprise silicon tetrachloride and phosphorus oxychloride. In the case where phosphorus oxychloride is used, the resultant as-deposited glass may be a phosphosilicate. As the glass transition temperature of the phosphosilicate is much lower than that of pure silica, the flame may traverse the deposition tube in an opposite direction as is typical in silica deposition. Further, a second traversal of the flame at a much lower temperature may be used in the sintering step.

In the step of solution doping, the deposition tube may be removed from the lathe in order to allow a solution of dopants to permeate through the deposited porous glass layer. The solution may comprise dopants, such as the matrix-defining dopant, active dopant, lasing dopant, stability dopant or mixtures thereof. After the solution has permeated the porous glass layer, the solution may be drained from the deposition tube, with some solution remaining entrained within the porosity of the deposited material.

The core is then allowed to dry. In embodiments, this drying step may comprise passing an inert gas, such as nitrogen, through the core.

The step of hydroxyl removal comprises passing a gas which can react and remove any terminal hydroxyl from the silica microparticles. As discussed above, hydroxyl groups may comprise an impurity, which can effect subsequent performance of an optical fiber. The temperature of the flame in this step may be gradually increased from 0° C. to 1500° C., such as by a rate of 100° C. per minute. Further, the flame may traverse the deposition tube at a rate of from 100 to 200 millimeters per minute, for a total number of traversals of the flame between 5 and 30 times.

One such gas that may react with any terminal hydroxyl group is chlorine gas. Thus, chlorine gas may be flowed through the deposition tube at a rate of from 10 to 100 sccm, while oxygen gas is flowed through the deposition tube at a rate of from 500 and 1000 sccm.

Without wishing to be bound to any particular theory, one method for reducing the conversion of dopants or the silica matrix into impurities involves the chlorine drying step described above. For instance, the chlorine drying step may allow excess hydrogen to be “scavenged” from the glass core. Excess hydrogen may enter the glass core through a variety of mechanisms, such as by through diffusion when a oxygen-hydrogen flame is used to heat the deposition tube. Hydrogen in the core may serve to reduce trivalent ytterbium to divalent ytterbium, and form terminal hydroxyl groups in the silica matrix.

The step of sintering may comprise passing the flame under the deposition tube, the flame being at a temperature of from 1500° C. to 2000° C. Further, the flame may traverse the deposition tube at a rate of from 15 to 100 millimeters per minute for a total number of traversals of from 1 to 4 times. Additionally, gases such as oxygen and chlorine may be flowed through the deposition tube. Chlorine gas may be flowed through the deposition tube at a rate of from 10 to 100 sccm, while oxygen gas may be flowed through the deposition tube at a rate of from 500 and 1000 sccm.

The step of collapse comprises increasing the temperature of the flame to a temperature sufficient to cause the glass microparticles to fuse into a unitary glass matrix while flowing an oxidizing gas through the deposition tube. For instance, the step of flame during collapse may have a temperature of from 2200° C. and 2700° C., such as of from 2300° C. and 2600° C. The flame may traverse the deposition tube at a rate of from 5 to 100 millimeters per minute, for a total number of traversals of from 1 to 5 times. Gases that may be flowed through the deposition tube during collapse may comprise oxygen at a flow rate of from 100 to 500 sccm and chlorine gas at a flow rate of from 5 to 100 sccm. Additionally, the total duration of the collapse step may last for between 30 and 80 minutes, such as between 45 and 75 minutes. One of skill in the art will appreciate, however, that the duration of the collapse step is at least partially subject to the temperature of the flame during the collapse step. After the step of collapse, a unitary glass matrix or glass preform may be obtained.

The step of collapse is one process where the present inventors have found that trivalent ytterbium may be reduced to divalent ytterbium. Without wishing to be bound to any particular theory, reduction of ytterbium may be caused by a lack of an oxidizing atmosphere during collapse, as well as a prolonged collapse duration at elevated temperatures.

The glass preform may then be formed into optical fibers, such as by drawing. In drawing, the optical preform is heated to a temperature where the glass preform softens. The glass preform can then be pulled through a series of gauges with progressively smaller diameters. The glass preform may thus be formed into glass optical fibers.

The fiber thereafter may be coated with a polymer coating. The polymer coating is not particularly limited, but may comprise an acrylate polymer.

Optical fibers may have a variety of form factors, each of which may be tailored to the specific application. For instance, these form factors include, but are not limited to, round, ovoid, and elliptical cross-sections. In certain embodiments, the optical fiber may be configured as a ribbon fiber, comprising a linear array of multiple individual fibers. Further, the optical fiber may be a single-mode fiber, typically with a round cross-section and a small core, or a multimode fiber, typically with a round cross-section and a larger core. The optical fiber may also be a polarization-maintaining (PM) fiber, typically with a round cross-section and stress-inducing rods. The optical fiber may be incorporated into a loose-tube cable, where the fiber is loosely contained within a protective tube, or a tight-buffered cable, where the fiber is tightly surrounded by a protective buffer layer.

As described above, the optical fiber may be coated with a polymer, or may be clad in a glass layer, or both. The cladding of an optical fiber may serve a role in guiding light along the fiber's core. Typically composed of a material with a lower refractive index than the core, the cladding creates a refractive index contrast that facilitates total internal reflection. This phenomenon ensures that light rays entering the core at sufficiently shallow angles are reflected back into the core, preventing light scattering and enabling efficient long-distance transmission. The material selection may vary, often involving doped or undoped silica, polymers, or other specialized glasses, depending on the application's requirements. In optical fibers as described above, the core of the optical fiber may have a diameter of from 5 to 50 microns, such as of from 10 to 30 microns. A cladding or coating layer, or plurality thereof, may surround the core of the optical fiber. The total diameter of an optical fiber, inclusive of the core and optional cladding or polymer coating, may be of from 75 to 750 microns, such as of from 100 to 200 microns, such as 125 microns.

In embodiments of the present invention, the self-cooling glass matrix of the present disclosure may be employed as a cooling mechanism for a device. For instance, in embodiments, the glass matrix of the present disclosure, rather than forming the core of an optical fiber, may comprise the cladding. In such a configuration, the core of an optical fiber may comprise an optical fiber as is known in the art, with the self-cooling glass matrix serving in a secondary, thermal management role.

The cooling capabilities of the glass matrix of the present disclosure are not so limited to applications involving the thermal management of an optical fiber. For instance, glass matrices of the present disclosure present an opportunity of solid-state cooling via radiation of a variety of devices. In such a case, glass matrices may be formed such that they have a form factor which optimizes the removal of heat from the device to be cooled. In embodiments wherein the glass matrix is used to cool device, the form factor is not so limited to that of optical fibers as disclosed above. For instance, the form factor may comprise, among other shapes, round, rectangular, hexagonal or trigonal cross-sections. When used to cool a device, glass matrices may have the form factors as described above in conjunction with thicknesses or radii in excess of 500 microns, such as thicknesses greater than 1000 microns.

The devices which may be cooled by glass matrices of the present disclosure are not particularly limited. For instance, the device may comprise electronics such as a microchip, such as an integrated circuit. In general, the device may comprise an apparatus which generates heat.

The present invention may be better understood with reference to the examples, set forth below.

### EXAMPLES

### Example 1: Optical Fiber Formation

The first step of this process simply pre-heats the substrate tube under oxygen and helium flow to evaporate any water that may have condensed in the tube during the construction of the workup. The second step introduces fluorinated precursors (C₄F₈ and/or SF₆) at high temperature to etch off the inner surface of the substrate, and any present contaminants with it, by the reaction presented in the equation below that converts SiO₂ to volatile SiF₄.

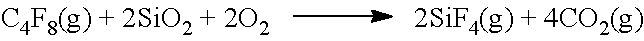

The third step stops the flow of fluorinated precursors and increases the temperature further in order to evacuate the tube of any remaining fluorinated species and fire polish the exterior of the substrate. The final step in this section introduces SiCl₄ at high temperature in order to deposit several (in this case five) thin, fully densified layers of SiO₂ to ensure a pristine inner surface for core deposition.

The purpose of the core deposition step is to introduce the material that will become the light-guiding core of the fiber. This step differs the most between the two recipe families (aluminosilicates and phosphosilicates). In both cases helium and oxygen are flowed through the tube in order to alter the thermal profile within the tube to promote thermophoretic deposition and ensure the oxidation of the precursor reagents is limited only by themselves. In the pure-silica soot case, SiCl₄ is introduced into the gas stream. The flame traverses in the forward direction at a temperature that is hot enough to drive the oxidation reaction, but cool enough that is does not completely densify the deposited soot as is passes over since thermophoretic deposition occurs “downstream” of the flame in MCVD. This creates a robust, but still porous, layer of silica glass that can be solution-doped in the next step.

In the phosphosilicate soot case, a mixture of SiCl₄ and POCl₃ are introduced into the gas stream. In these methods, the flame traverses in the reverse direction. This is because the glass transition temperature of phosphosilicate glass is much lower than the pure silica glass soot and so the temperature required to drive the oxidation reaction to completion would over densify the deposited glass layer and not leave sufficient porosity for solution doping. In this case a second pass at a much lower temperature is used to sinter the deposited soot sufficiently to achieve the robustness required to survive solution doping.

As described previously, a solution-doping process is used to incorporate dopants into the soot that do not have suitable vapor-phase precursors. This step is also effectively identical between the two recipe families. The handle and substrate tube are separated from the rest of the workup and removed from the lathe. This portion of the workup is placed on a stand vertically and the end of the substrate is plugged with a rubber stopper. A peristaltic pump is used to pump the doping solution into the substrate tube. In general, solutions for this experiment were prepared using deionized water, produced by an in-lab filtration system, into which aluminum chloride hexahydrate (AlCl₃) and ytterbium chloride hexahydrate (YbCl₃) salts were dissolved to achieve the desired dopant concentration.

Once full it is allowed to sit for one hour to ensure the soot is completely soaked with solution. The excess solution not contained within the pores of the soot layer is then pumped back into its container. The soaked soot layer is allowed to dry under nitrogen purge. The handle and substrate tube are then returned to the lathe and re-welded to the remainder of the workup. Oxygen and helium are flowed through the tube and the substrate is heated in order to oxidize the salts remaining from the evaporated solution and fully consolidate the deposited soot into a fully-densified glass layer containing the additional dopants introduced from the solution. As has been discussed, chlorine gas may be added to these steps in order to remove hydroxyl impurities introduced by protic solvents used in the doping solutions. The concentrations of dissolved salts in the doping solutions as well as the porosity of the deposited core glass layer determine the amount of incorporated dopants and thus the final doping concentration of the core glass.

The purpose of the collapse step is to convert the substrate tube and deposited core material into a solid rod, called a preform, which can be drawn into optical fiber. The substrate tube is heated to very high temperatures (upwards of 2400° C.) as the burner traverses slowly. At these high temperatures the silica substrate softens and surface tension causes it to contract in size. Over the course of several passes (3 for this experiment) the tube is collapsed into a solid rod. Oxygen is flowed through the tube to prevent reduction of dopants and to provide positive pressure which helps keep the preform circular as it collapses. Additional gases and precursors may also be flowed through the tube during collapse to offset the burnout of certain volatile dopants, such as phosphorus oxide. At the completion the collapse step, the solid glass preform can be separated from the workup by the use of a hand torch and be characterized or drawn into fiber.

### Example 2: Example MCVD Parameters

The below table shows various process parameters for a modified chemical vapor deposition run.

| | | Burner | Burner | Process Gas |
|---|---|---|---|---|
| | # of | Temperature | Traverse | Flows |
| Step | Passes | [° C.] | Speed | [sccm] |
| Dry/Prheat | 2 | 1750 | 200 | 2000 O2, 2000 He |
| Etch | 2 | 2100 | 170 | 1000 o, 500 he, |
| | | | | 100 c4f8, 12 sf |
| Fire Polish | 2 | 2200 | 170 | 1000 o, 500 he |
| Cladding | 5 | 2100 | 140 | 1000 o, 1500 he, |
| Deposition | | | | 500 sicl4 |
| Core Deposition | 1 | 1550 | 140 | 300 o, 340 he, |
| | | | | 160 sicl4 |
| Solution Dope | N/A | N/A | N/A | N/A |
| Cl2 Dry | 20 | Ramp | 150 | 760 o, 40 cl2 |
| | | 0-1000 | | |
| Sinter | 1 | 1750 | 30 | 760 o, 40 cl2 |
| Collapse 1 | 1 | 2400 | 15 | 250 o, 12.5 cl2 |
| Collapse 2 | 1 | 2400 | 12 | 250 o, 12.5 cl2 |
| Clase | 1 | 2400 | −10 | 400 o |

### Example 3: Fiber Draw

Preforms are drawn into optical fiber using a fiber draw tower. Fibers in this experiment were drawn on a 6.5 meter-tall Heathway draw tower at Clemson University. In this process, a feed mechanism inserts the (MCVD) preform into the top of a high temperature, argon-purged, Centorr graphite resistive furnace, which heats the preform to a temperature where it softens and can be drawn out into fiber by tension provided by a capstan at the bottom of the tower. After exiting the furnace, the fiber passes through a series of Zumbach ODAC 14XY optical diameter gauges that monitor the fiber size and adjusts the capstan draw speed to keep the diameter to within 1% of the target diameter. Along its descent the fiber passes through a coating die where a protective layer of acrylate polymer is applied before being cured by a UV lamp. After passing around the capstan, the fiber is wound onto a spool. Fibers produced for this work were drawn at 1925° C. to a target diameter of 125 μm. Feed and draw speeds for this experiment were around 1 mm/min and 10m/min, respectively. A protective single layer of DeSolite 3471-3-14 acrylate coating, approximately 60 μm thick was applied to the exterior of the fiber.

### Example 4: Fiber Composition

Scanning electron microscopy (SEM) and energy dispersive x-ray (EDX) spectroscopy techniques were performed on each fiber to confirm the core diameter and measure core compositional profiles. SEM and EDX measurements were made at the Clemson University Electron Microscopy Facility using a Hitachi SU5000 scanning electron microscope equipped with an Oxford Instruments X-Max EDX detector. Compositional profiles were taken across the diameter of the core of each fiber with measurement points spaced 0.5 μm apart. Measurements were taken with an accelerating voltage of 20 keV at a working distance of 10 mm in a high vacuum. To prevent charging, fiber samples were coated with a layer of platinum approximately 60 nm thick using an Antech LTD HUMMER 6.2 sputtering system. The compositions of five example optical fibers are presented below.

| | Core Diameter | [Yb] | [Al] | [F] | [Yb2+] | [OH] |
|---|---|---|---|---|---|---|
| Fiber | (μm) | (wt. %) | (wt. %) | (wt. %) | (ppm) | (ppm) |
| A | 10 | 1.76 | 1.86 | 0 | 2.7 | 1.9 |
| B | 10 | 1.26 | 1.57 | 0 | 1.7 | 1.9 |
| C | 10 | 1.36 | 1.31 | 0 | 1.3 | 1.6 |
| D | 10 | 1.65 | 1.86 | 0 | 0.3 | 6.4 |
| E | 21 | 2.06 | 0.86 | 0.88 | 0 | 1.5 |

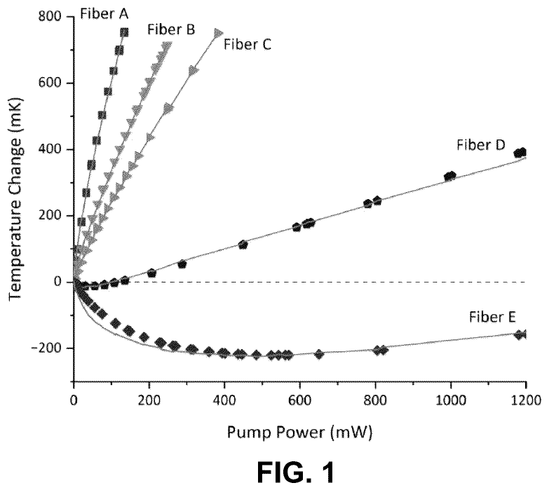

The ability of the above optical fibers to exhibit cooling via anti-Stokes may be seen in FIG. 1. As can be seen from FIG. 1 and the above table, a trend is observed wherein decreasing concentrations of divalent ytterbium in the glass matrix decrease the extent to which heat is generated in an optical fiber when pumped. For instance, while the absolute degree of cooling of a particular fiber of the present disclosure may vary depending on a variety of factors, such as concentration of trivalent ytterbium, form factor or cross-sectional area, Fiber E exhibits negative temperature change across a wide domain of pump powers.

### Example 5: Fiber Attenuation

Fiber attenuation measurements were conducted in the ultraviolet and visible spectral range using an Ocean Optics MAYA (170-330 nm) spectrometer or a combined deuterium and halogen light source coupled to an Ocean Optics 2000+ (200-1050 nm) spectrometer. For attenuation spectra in the near-infrared (NIR; 1100-1500 nm), a halogen light source connected to an ANDO AQ6315E optical spectrum analyzer was employed. The cut-back method was applied, starting with fiber lengths of between 50 to 100 meters for the NIR measurements, a few meters in the visible range, and a few millimeters for measurements in the UV range. In the cases in which they are discussed, concentrations of Yb²+ and OH impurities calculated based on the measured attenuation at wavelengths of 325 nm and 1383 nm, respectively. The conversion factors employed were 217 dB/m/ppm (at 325 nm) for Yb²+ as and 55 dB/km/ppm (at 1383 nm) for OH. Shown below are the attenuations for Yb²+, Yb³+, baseline, and OH.

| | 325 nm | 920 | 1200 nm | 1383 nm |
|---|---|---|---|---|
| | (Yb²+) | (Yb³+) | (baseline) | (OH) |
| Fiber | [dB/m] | [dB/m] | [dB/km] | [dB/km] |
| A | 5788.3 | 315.4 | 81 | 105.9 |
| B | 3677.4 | 263.9 | 45.5 | 106.9 |
| C | 2790.6 | 288.4 | 33 | 90.2 |
| D | 546.3 | 322.7 | 11.2 | 350.6 |
| E | 11.9 | Blank | 11.3 | 82 |

### Example 6: Cooling Experiments

Cooling experiments were performed by core-pumping the fiber under test with a continuous-wave Yb-doped fiber laser at 1040 nm. This wavelength was selected to be longer than the mean spontaneous-emission wavelength of the Yb-doped silica in order to induce anti-Stokes fluorescence cooling. Each fiber was cut to a length of ˜1 m. Roughly in the middle of the fiber, a short segment of the polymer coating (˜15 cm) was stripped off to prevent absorption of the anti-Stokes fluorescence, which would otherwise heat the fiber and offset the cooling. At the stripped segment, the Yb-doped fiber temperature was measured with a high-precision slow-light fiber-Bragg-grating sensor placed in contact with the test fiber's bare cladding. To establish a good physical contact between the two fibers, the sensor fiber was kept straight, and the Yb-doped fiber was twisted around the sensor fiber. This sensor exhibits a resolution of a few millikelvin, a small drift of less than 5 mK per minute, and high repeatability. The fibers were at atmospheric pressure and suspended off the optical table inside a double enclosure to minimize temperature fluctuations due to air currents.

As shown in FIG. 1, Fiber E, the fiber with the least divalent ytterbium, exhibited negative temperature change across a wide range of pump powers. In this plot it can be observed that Fiber E cooled significantly to ˜225 mK below room temperature at ˜500 mW before beginning to heat due to background absorption. Fiber D exhibited a similar behavior, except that it reached a minimum temperature of only −15 mK below room temperature when pumped with ˜30 mW, before heating to above room temperature for pump powers above ˜120 mW. Fibers A, B, and C did not exhibit cooling at all. Their temperature rose immediately when the pump power was increased from zero. This indicates that at all pump powers, the extracted energy by anti-Stokes fluorescence was insufficient to negate the heat generated by internal heating mechanisms, namely quenching and/or background absorption. In summary, the fibers performed better in increasing alphabetic order, from A to E.

Further experiments were conducted with different families of silicate glasses, including aluminofluorosilicate, aluminosilicate, alumina silicate with barium fluoride nanoparticles, phosphosilicate and aluminophosphosilicate. The approximate dopant concentrations and results are shown below.

| | | | | Absorbed | |
|---|---|---|---|---|---|
| | | | Maximum | Pump | |
| Core | Approx. | | Cooling | Power | |
| Glass | Dopant | Core | (\|ΔT\| max) | (Δpabs/L) | Cooling |
| Family | Concentration | Diameter | [mK] | [mW/m] | Efficiency |
| AFS | 2.06 wt. % Yb | 21 | 225 | 370 | 1.90% |
| | 0.86 wt. % Al | | | | |
| | 0.88 wt. % F | | | | |
| AS | 1.9 wt. % Yb | 10 | 80 | 130 | 2.00% |
| | 3.0 wt. % Al | | | | |
| AS | 1.4 wt. % Yb | 9 | 58 | 100 | 1.90% |
| (BaF2 NP) | 1.2 wt. % Al | | | | |
| | 1.5 wt. % Ba | | | | |
| PS | 3.5 wt. % Yb | 16 | 140 | 150 | 3.00% |
| | 1.3 wt. % Al | | | | |
| | 7.5 wt. % P | | | | |
| APS | 6.0 wt. % Yb | 14 | 200 | 360 | 1.80% |
| | 5.0 wt. % Al | | | | |
| | 10.0 wt. % P | | | | |
| APS | 6.2 wt. % Yb | 16 | 250 | 600 | 2.20% |
| | 9.5 wt. % Af | | | | |
| | 14.0 wt. % P | | | | |

### Example 7: Fluorescence Lifetime

All upper-state Yb³+ lifetime measurements were obtained by pumping each experimental fiber with a pulsed 976-nm diode laser stabilized with a fiber Bragg grating (FBG) (JDSU S31-7602-720) and collecting and analyzing the resulting fluorescence signal. Each sample was first fusion-spliced to a segment of 1060-XP (Coherent) fiber serving as sacrificial fiber. The length of every fiber under test was kept to 1 mm to avoid the reabsorption of fluorescence. Then, 15 cm of a multimode fiber (MMF) with a 100-μm core diameter was spliced to the end of the Yb-doped fiber to avoid any potential damage to the sample during measurement. The two splices on either side of each sample were meticulously executed with weaker arcs to reduce potential annealing effects that would alter the lifetime of the Yb³+ ions. The MMF segment was then flat-cleaved and placed within a temporary bare fiber terminator and the light emerging from the fiber was collimated with an aspheric lens. This signal was sent through two filters: 1) a 1-μm long pass filter (FELH1000) and 2) a single 1-μm band-pass filter (FBH1000-10). Combined, these two filters provided an extinction ratio of −78 dB at 976 nm. The filtered beam was then focused onto an InGaAs avalanche photodiode (Thorlabs APD410C).

All measurements were completed at an input peak power of ˜600 mW with a pulse repetition interval of 40 ms and a pulse width of 300 μs. Given the low duty cycle (0.75%) and FBG stabilization of its wavelength, temperature control of the laser diode was not required to maintain the pumping wavelength of 976 nm. The system response is limited by the 10 MHz output bandwidth of the APD. Despite the large extinction at 976 nm by the filter pair, fluorescence originating at the pump laser can still make its way to the detector. With the filters in place, and with no test fiber present, the fall time of the measurement system, when at the operating point, was measured to be approximately 100 ns. Therefore, any fast decay components with characteristic time constants much less than 100 ns cannot be resolved. Fast components with lifetimes comparable to 100 ns, on the other hand, are resolvable but require deconvolution from the instrument response. The results of the fluorescence lifetime measurements are shown below.

| | 1/e | | | Normalized |
|---|---|---|---|---|
| | Fluorescence | Fast | Slow | Fast |
| | Lifetime | Time | Time | Component |
| Fiber | [μs] | Constant | Constant | Amplitude |
| A | 765 | 233 | 799 | 0.045 |
| B | 782 | 184 | 807 | 0.032 |
| C | 791 | 222 | 812 | 0.029 |
| D | 809 | 148 | 825 | 0.019 |
| E | 895 | 173 | 907 | 0.015 |

### Example 8: Impurity Contents

One potential source of impurities in these CVD-produced glasses is the solution doping process. As described above in the methods section regarding solution doping, dopants that do not have suitable vapor phase precursors must be introduced to the glass via solution. Since these solution-based precursors cannot leverage differences in vapor pressure to purify the chemical during the process, the purity of the dopants introduced by solution doping is only as good as that of their starting salts. Salts used to make the doping solutions used in these experiments were the highest purities readily available through the university's contracted vendors. The purity of these salts was quite high for industrially produced chemicals at five-nines, or approximately 99.999% pure, but this is a far cry from the purity of the CVD vapor stream which can be upwards of fifteen-nines in purity. The lanthanide elements are difficult to separate from each other given their incredibly similar charge, ionic radius, and atomic weight. The below table shows the impurities in the ytterbium chloride hexahydrate used for the above experiments.

| | Atomic |
|---|---|
| | concentration |
| Element | [ppm] |
| Silver | 0.3 |
| Aluminum | 0.8 |
| Boron | 0.2 |
| Bismuth | 0.3 |
| Calcium | 3.7 |
| Copper | 0.1 |
| Iron | 0.8 |
| Iridium | 6.3 |
| Potassium | 0.8 |
| Lithium | 0.1 |
| Magnesium | 0.2 |
| Sodium | 6.7 |
| Nickel | 0.1 |
| Lead | 0.6 |
| Strontium | 0.2 |
| Vanadium | 0.1 |
| Zinc | 1.2 |
| Dysprosium | 0.3 |
| Erbium | 0.8 |
| Holmium | 0.2 |
| Lutetium | 14.9 |
| Thulium | 8.0 |
| Yttrium | 0.2 |
| Total Impurity | 46.9 |

While certain embodiments of the disclosed subject matter have been described using specific terms, such description is for illustrative purposes only, and it is to be understood that changes and variations may be made without departing from the spirit or scope of the subject matter.

What is claimed is:

1. An optical fiber comprising a core comprising a silica matrix and an active dopant disposed within the silica matrix, wherein a trivalent form of the active dopant is present in the silica matrix in an amount greater than 2.1 wt. % and a divalent form of the active dopant is present in the silica matrix in an amount less than 1.0 wt. ppm.

2. The optical fiber of claim 1, wherein the active dopant comprises a rare earth.

3. The optical fiber of claim 1, wherein the active dopant comprises ytterbium.

4. The optical fiber of claim 1, wherein the trivalent form of the active dopant is present in the silica matrix at a concentration of greater than 5.6 wt. % of the silica matrix.

5. The optical fiber of claim 1, wherein the silica matrix comprises an aluminosilicate matrix.

6. The optical fiber of claim 1, wherein the silica matrix comprises a phosphosilicate matrix.

7. The optical fiber of claim 1, wherein the silica matrix comprises an aluminophosphosilicate matrix.

8. The optical fiber of claim 1, wherein the silica matrix comprises less than 7.0 wt. ppm hydroxyl units.

9. The optical fiber of claim 1 further comprising a lasing dopant.

10. The optical fiber of claim 1, comprising between 20 and 50 ppm of impurities.

11. A cooling system for an optical fiber, the system comprising an optical fiber core and a cladding disposed on an exterior surface of the optical fiber core, the cladding comprising a silica matrix and an active dopant disposed within the silica matrix, wherein a trivalent form of the active dopant is present in the silica matrix in an amount greater than 5.6 wt. % and a divalent form of the active dopant is present in the silica matrix in an amount less than 1.0 wt. ppm.

12. The cooling system of claim 11, wherein the active dopant comprises ytterbium.

13. The cooling system of claim 11, wherein the trivalent form of the active dopant is present in the silica matrix at a concentration of greater than 8.0 wt. % of the silica matrix.

14. The cooling system of claim 11, wherein the silica matrix comprises an aluminosilicate matrix.

15. The cooling system of claim 11, wherein the silica matrix comprises a phosphosilicate matrix.

16. The cooling system of claim 11, wherein the silica matrix comprises an aluminophosphosilicate matrix.

17. A silica matrix comprising a silica matrix and an active dopant disposed within the silica matrix, wherein a trivalent form of the active dopant is present in the silica matrix in an amount greater than 8.9 wt. %.

18. The silica matrix of claim 17, wherein the silica matrix comprises an aluminosilicate matrix.

19. The silica matrix of claim 17, wherein the silica matrix is in thermal contact with a device.

20. The silica matrix of claim 19, wherein the device comprises a microchip.
